(19) United States
(12) Patent Application Publication
(10) Pub. No.: US 2007/0196627 A1
(43) Pub. Date: Aug. 23, 2007

(54) PHOTOLUMINESCENT SCREWDRIVER

(75) Inventor: Jui-Hsiao Wang, Tainan (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: COMPASS CORP., Yung-Kang (TW)

(21) Appl. No.: 11/307,693

(22) Filed: Feb. 17, 2006

(51) Int. Cl. B41M 5/00

(52) U.S. Cl. 428/195.1

(57) ABSTRACT

A photoluminescent screwdriver includes a handle, a photoluminescent member, and a shank. The handle includes at least one transparent portion and an engaging hole. The photoluminescent member is mounted in the engaging hole of the handle and includes a longitudinal hole. The photoluminescent member further includes an indicia on an outer surface thereof or having a color. The shank includes a rear end engaged in the longitudinal hole of the photoluminescent member.

### BACKGROUND OF THE INVENTION

1. Field of the Invention

The present invention relates to a screwdriver and more particularly, to a photoluminescent screwdriver.

2. Description of the Related Art

A typical screwdriver comprises a handle and a shank for tightening/unfastening a fastener such as a screw or the like. The handle is generally made of rigid material and includes an anti-slip arrangement on a surface thereof. Trademark or the specification such as the size of the screwdriver is provided on the surface for identification purposes. However, the trademark or specification of the screwdriver could not be seen at night. Further, conventional screwdrivers are monotonous in appearance.

### BRIEF SUMMARY OF THE INVENTION

A photoluminescent screwdriver in accordance with of the present invention comprises a handle, a photoluminescent member, and a shank. The handle comprises at least one transparent portion and an engaging hole. The photoluminescent member is mounted in the engaging hole of the handle and includes a longitudinal hole. The photoluminescent member further includes an indicia on an outer surface thereof or having a color. The shank includes a rear end engaged in the longitudinal hole of the photoluminescent member.

Preferably, the handle is made of transparent plastic material.

Preferably, the photoluminescent member is made of photoluminescent powders and plastic material including at least one of polypropylene, polycarbonate, and acrylonitrile butadiene styrene.

Preferably, the photoluminescent member is hexagonal.

Preferably, the longitudinal hole of the photoluminescent member is hexagonal and the rear end of the shank is removably mounted in the longitudinal hole of the photoluminescent member.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a photoluminescent screwdriver in accordance with the present invention.

FIG. 2 is an exploded perspective view of the photoluminescent screwdriver in accordance with the present invention.

FIG. 3 is a sectional view of the photoluminescent screwdriver in accordance with the present invention.

FIG. 4 is a sectional view taken along plane 4-4 in FIG. 3.

FIG. 5 is an exploded perspective view of a modified embodiment of the photoluminescent screwdriver in accordance with the present invention.

### DETAILED DESCRIPTION OF THE INVENTION

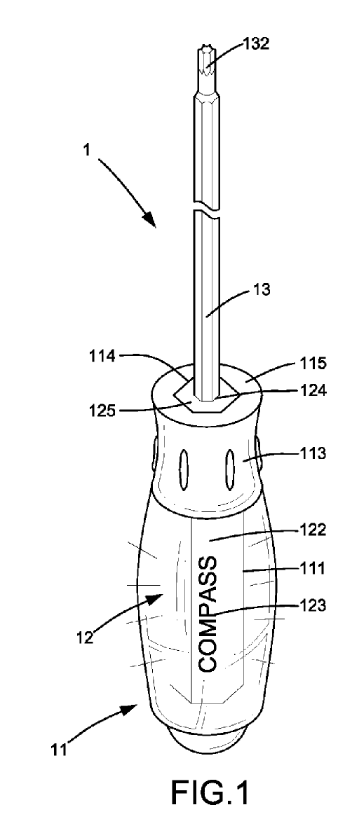

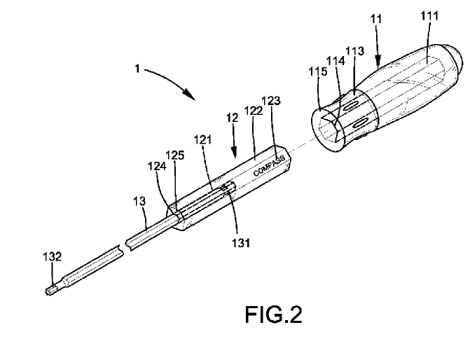

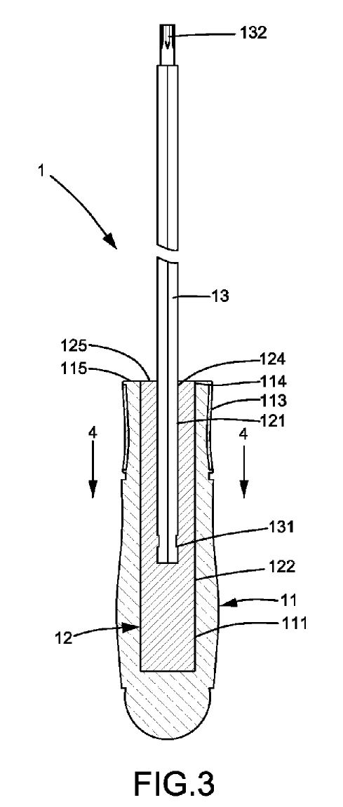

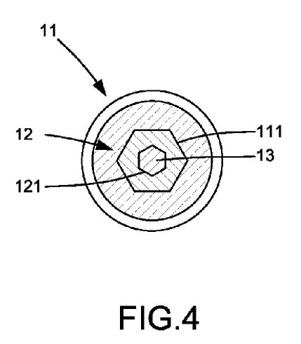

Referring to FIGS. 1 through 4, a photoluminescent screwdriver 1 in accordance with the present invention comprises a handle 11, a photoluminescent member 12, and a shank 13. The handle 11 is preferably made of transparent plastic material or includes at least one transparent portion. The handle 11 includes an engaging hole 111 for securely receiving the photoluminescent member 12. In this example, the engaging hole 111 is hexagonal in section and includes an opening 114 in a front end 115 of the handle 11. The handle 11 may further include a rubber coating layer 113 on an outer surface of the front end 115 for increasing the frictional force when gripped by a user.

The photoluminescent member 12 in this example is hexagonal in shape and made of photoluminescent powders and plastic material including at least one of polypropylene (PP), polycarbonate (PC), and acrylonitrile butadiene styrene (ABS). Preferably, the photoluminescent member 12 absorbs sunlight during the day and glows in the dark. An outer diameter of the photoluminescent member 12 is preferably slightly smaller than an inner diameter of the engaging hole 111 such that the photoluminescent member 12 can be mounted into the engaging hole 111 by force-fitting via the opening 114. Thus, the photoluminescent member 12 turns jointly with the handle 11. Alternatively, the photoluminescent member 12 is mounted inside the handle 11 by injection molding.

The photoluminescent member 12 includes a longitudinal hole 121 for receiving an end of the shank 13. In this example, the longitudinal hole 121 is hexagonal in section and includes an opening 124 in a front end 125 of the photoluminescent member 12. Indicia 123 such as trademarks, patterns, the specification of the screwdriver, or other letters can be provided on an outer surface of the photoluminescent member 12 for viewing and identification purposes.

The shank 13 includes a front end 132 and a rear end 131. In this example, the rear end 131 of the shank 13 is engaged in the longitudinal hole 121 by injection molding. Alternatively, the rear end 131 of the shank 13 can be inserted via the opening 124 into the longitudinal hole 121 of the photoluminescent member 12, thereby mounting the shank 13 to the photoluminescent member 12. The front end 132 of the shank 13 may be of any desired shape for driving a screw with a correspondingly shaped groove or slot.

The photoluminescent screwdriver 1 in accordance with the present invention provides the conventional screw tightening/unfastening functions as well as easy grip and anti-slip. Further, the indicia 123 on the outer surface 122 of the photoluminescent member 12 can be seen through the transparent portion of the handle 11 (or the transparent handle 11) at any time and any place. Preferably, the transparent portion of the handle 11 may include an arcuate face for magnifying the indicia 123. Further, the photoluminescent member 12 provides an illuminating function in the dark. Further, a decoration effect is provided in a case that the photoluminescent member 12 is dyed or aesthetic patterns are provided on the surface 122 of the photoluminescent member 12, for a colorful visual effect can be obtained through the transparent portion of the handle 11 (or the transparent handle 11).

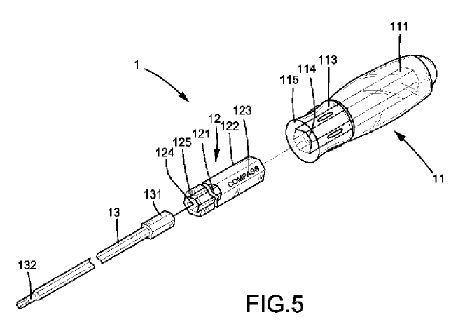

FIG. 5 illustrates a modified embodiment of the invention, wherein the shank 13 can be detached from the photoluminescent member 12. In this example, the rear end 131 of the shank 13 is hexagonal and removably mounted in the hexagonal longitudinal hole 121 of the photoluminescent member 12. By such an arrangement, shanks 13 of various sizes and types can be used.

Although specific embodiments have been illustrated and described, numerous modifications and variations are still possible without departing from the essence of the invention. The scope of the invention is limited by the accompanying claims.

What is claimed is:

1. A photoluminescent screwdriver comprising:
a handle comprising at least one transparent portion and an engaging hole;
a photoluminescent member mounted in the engaging hole, the photoluminescent member including a longitudinal hole, the photoluminescent member further including an indicia on an outer surface thereof or having a color; and
a shank including a rear end engaged in the longitudinal hole of the photoluminescent member.

2. The photoluminescent screwdriver as claimed in claim 1 wherein the handle is made of transparent plastic material.

3. The photoluminescent screwdriver as claimed in claim 1 wherein the photoluminescent member is made of photoluminescent powders and plastic material including at least one of polypropylene, polycarbonate, and acrylonitrile butadiene styrene.

4. The photoluminescent screwdriver as claimed in claim 1 wherein the photoluminescent member is hexagonal.

5. The photoluminescent screwdriver as claimed in claim 1 wherein the longitudinal hole of the photoluminescent member is hexagonal and wherein the rear end of the shank is removably mounted in the longitudinal hole of the photoluminescent member.
